(19) United States
(12) Patent Application Publication
(10) Pub. No.: US 2026/0054461 A1
(43) Pub. Date: Feb. 26, 2026

(54) UNDULATED SIPE-MOLDING MEMBER FOR IMPROVED TIRE PERFORMANCE AND ECONOMICAL MOLD FABRICATION

(71) Applicants: Sadi KOSE, Greenville, SC (US); COMPAGNIE GENERALE DES ETABLISSEMENTS MICHELIN, Clermont-Ferrand (FR)

(72) Inventors: Bertrand BOISDON, Clermont-Ferrand (FR); Violaine TODOROFF, Clermont-Ferrand (FR); Sadi KOSE, Taylors, SC (US)

(21) Appl. No.: 19/104,964

(22) PCT Filed: Aug. 29, 2023
(86) PCT No.: PCT/US2023/031370

§ 371 Date: Feb. 19, 2025

Related U.S. Application Data
(60) Provisional application No. 63/401,974, filed on Aug. 29, 2022.

(51) Int. Cl. B29D 30/06

(52) U.S. Cl. CPC B29D 30/0606; B29D 2030/0613

(57) ABSTRACT

A tire mold and method of making a tire mold having a plurality of sipes, each sipe is arranged between opposing surfaces of the tread within the tread thickness and each sipe having a thicker frame portion (40) which meets with and extends beyond and into the ground engaging surface of the tire tread and a thinner portion (42) forming a plurality of projections (36) on at least one of opposing sides of the sipe thickness, the plurality of projections being spaced apart, each projection has a height no greater than the thickness of the frame portion of the sipe.

### FIELD OF THE INVENTION

This invention relates to tire treads, and more specifically, to the arrangement and formation of sipes within a tire tread, the molds used to manufacture the tire treads and to the method of making such molds having complex sipe-molding member geometry.

### BACKGROUND OF THE INVENTION

Sipes are commonly employed in tire treads. Sipes form very narrow grooves or slits within a thickness of the tire tread and are configured to close or remain closed at some instance within a footprint during tire operation. A footprint refers to the area of contact between a tire and a ground surface. In certain instances, to generate an interlocking effect between opposing tread surfaces between which the sipe is arranged (that is, between opposing sides of the tread forming the sipe), the opposing sides or surfaces undulate in both a depthwise direction and a lengthwise direction of the sipe. This interlocking can improve tread wear, but may degrade rolling resistance. More sophisticated undulating lamelles, such as found in U.S. Pat. No. 11,338,618 that address these issues result in fragile mold components that add cost and expense to tire manufacturing making further use of this technology cost prohibitive particularly in multi-segment tire molds such as tire puzzle molds. Such complex tire sipe geometry would traditionally require flexible or frangible mold negatives (herein used to describe the positive blank used to cast the mold and having the geometry of the finished product) to allow for release of the complex geometry of the sipe-molding member from the mold negative when imbedded in the mold which add expense. Therefore, there is a need to both improve tread wear and reduce rolling resistance while reducing manufacturing expense.

### SUMMARY OF THE INVENTION

Particular embodiments of the present invention include tire treads having a plurality of sipes where at least one of the opposing sides of the sipe thickness includes a plurality of projections and a method for forming the same.

Particular embodiments of a tire tread having a plurality of sipes includes a tire tread comprising a length extending in a lengthwise direction, the lengthwise direction being a circumferential direction when the tread is arranged on a tire, a width extending in a lateral direction, the lateral direction being perpendicular to the lengthwise direction, and a thickness extending in a depthwise direction from an outer, ground-engaging side of the tread, the depthwise direction being perpendicular to both the lengthwise direction and the widthwise direction of the tread. The plurality of sipes each have a length extending at least partially in a direction of the tread length or width, a height extending at least partially in a direction of the tread depth and perpendicular to the tread length, and a thickness. Each sipe is arranged between opposing surfaces of the tread within the tread thickness. Each sipe has a thicker frame portion (or “thick portion”) and a thinner portion forming a plurality of projections on at least one of opposing sides of the sipe thickness, the plurality of projections being spaced apart. In certain instances, each projection has a height no greater than the thickness of the frame portion of the sipe.

In particular embodiments a method for forming the tire tread having a plurality of sipes includes a step of molding each of a plurality of sipes using a sipe-molding member. Each sipe-molding member has a length configured within the tread to extend at least partially in a direction of the tread length or width, a height configured within the tread to extend at least partially in a direction of the tread depth and perpendicular to the tread length, and a thickness. Each sipe-molding member is arranged between opposing surfaces of the tread within the tread thickness. At least one of opposing sides of the sipe-molding member thickness includes a plurality of projections being spaced apart. The method for forming the tire tread having a plurality of sipes further includes removing the sipe-molding member and leaving a sipe remaining within the tread. The sipe has a void shaped as the sipe-molding member and a plurality of projections corresponding to the plurality of projections arranged along the sipe-molding member.

In other embodiments a mold component and method for making the mold component is disclosed for the use of manufacturing a tire having a plurality of sipes having a complex geometry.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a tire tread having an embodiment of a sipe in accordance with the invention disclosed herein.

FIG. 2 provides a close-up perspective view of the tire shown in FIG. 1.

FIG. 3 provides a perspective view of an embodiment of a sipe-molding member having a thick frame-forming portion and a thin undulated portion, the sipe-molding member having an undulation along the length of the sipe-molding member.

FIG. 4 provides a top view of the sipe-molding member of FIG. 3.

FIG. 5 provides a cross section of the sipe-molding member taken on line 5-5 take in FIG. 3.

FIG. 6 provides a cross section of the sipe-molding member taken on line 6-6 take in FIG. 3.

FIG. 7 provides a perspective view of an embodiment of a sipe-molding member having a thick frame-forming portion and a thin undulated portion, the sipe-molding member having a curved undulation along the length of the sipe-molding member.

FIG. 8 provides a top view of the sipe-molding member of FIG. 7.

FIG. 9 provides a cross section of the sipe-molding member taken on line 9-9 take in FIG. 7.

FIG. 10 provides a cross section of the sipe-molding member taken on line 10-10 take in FIG. 7.

FIG. 11 provides a perspective view of an embodiment of a sipe-molding member having a thick frame-forming portion and a thin undulated portion.

FIG. 12 provides a cross section of the sipe-molding member taken on line 12-12 take in FIG. 11.

FIG. 13 provides a cross section of the sipe-molding member taken on line 13-14 take in FIG. 11.

FIG. 14 provides a perspective view of a mold component used to mold a tire and having an embodiment of a sipe-molding member.

FIG. 15 provides a perspective view of a mold negative for forming a mold component used to mold a tire and having an embodiment of a sipe-molding member.

FIG. 16 shows the insertion of a sipe-molding member into a mold negative.

FIG. 17 shows the casting of mold material used to form the tire mold component into the mold negative.

FIG. 18 shows the separation of the mold component from the mold negative with the sipe-molding member embedded in the mold component.

The use of identical or similar reference numerals in different figures denotes identical or similar features.

### DETAILED DESCRIPTION OF THE INVENTION

The present invention includes tire treads, tires including such treads, methods for forming tire treads, molds, and methods for forming the molds, where any such tread includes a sipe having the surface geometry described herein. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

With regard to the tire treads described herein, it is appreciated that each such tread includes a length, width, and thickness. The length extends in a lengthwise direction. As the tread may be formed with the tire, or separately for later installation on the tire, such as during retreading operations, for example, the lengthwise direction of the tread is a circumferential (that is, annular) direction when the tread is arranged on a tire. The width extends in a lateral direction, the lateral direction being perpendicular to the lengthwise direction, while the thickness extends in a depthwise direction from an outer, ground-engaging side of the tread, the depthwise direction being perpendicular to both the lengthwise direction and the widthwise direction of the tread.

This invention introduces a surface geometry of the sipe which increases the surface friction between, and improved interlocking between, opposing sides of the tread between which the sipe is arranged while improving the demoldability of the tire tread from the mold and increasing the durability of the tire tread mold components responsible for creating the sipe feature all while allowing for economical mold manufacturing methods to be employed. In turn, improvements in wear may be achieved comparable to traditional undulated sipe while reducing mold wear and tear, reducing downtime and scrapped tires and reducing the cost of manufacturing each tire mold and tire without significant degradation to rolling resistance. Additionally, because the new surface geometry further increases the durability of the sipe-molding mold member, a wider sipe-molding area along the mold member may be increased and/or the thickness of the sipe-molding area may be reduced, each of which can lead to further improvements in wear without significant degradation in rolling resistance.

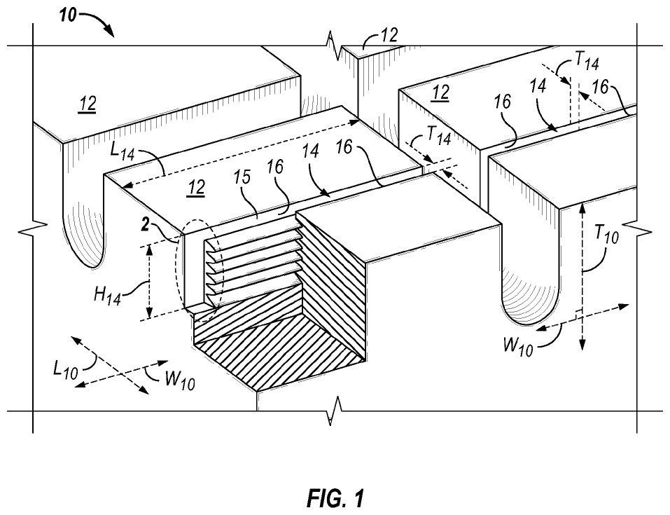

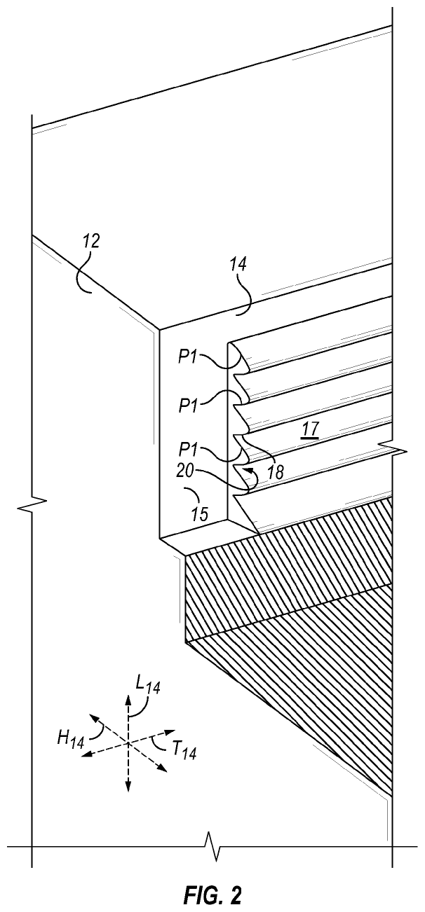

It is appreciated that the surface geometry described herein may be applied to any sipe known to one of ordinary skill in the art, or obvious variation thereof. For example, with reference to an exemplary embodiment shown in FIG. 1, a partial perspective view of a tire tread 10 is shown having a plurality of tread blocks 12 each including a sipe 14. One sipe 14 is shown in greater particularity in a partial cutaway of a particular tread block 12, which is then shown in an enlarged view in FIG. 2. As shown, tread 10 includes a plurality of sipes 14 each having a length L14 extending at least partially in a direction of the tread length L10 or width W10, a height H14 extending at least partially in a direction of the tread depth T10 and perpendicular to the tread length, and a thickness T14. As best seen in FIG. 1, each sipe 14 is arranged between opposing sides or surfaces 16 of the tread within the tread thickness.

It is appreciated that the sipe may form a planar or contoured sipe. In other words, the body of the sipe may be planar or contoured. A planar sipe may also be referred to as a straight sipe. A contoured sipe is non-planar, where the thickness extends in a direction of the sipe length and/or height along any desired non-linear path, which may be a curvilinear path or an undulating path, for example. In an exemplary embodiment, as can be seen in FIGS. 1-2, the sipe thickness T14 (forming a body of the sipe) changes from a thicker frame portion 15 to an undulating thin portion 17 which undulates back and forth along a first path P1 in a direction of the tread length L10 as the sipe extends in a direction of the sipe height H14, which is also the direction of the tread depth T10 in the embodiment shown. The thin portion may be 0.15 mm to 0.4 mm thick in at least one embodiment. In other variations, the first path undulates back and forth in a direction of the tread length L10 while the first path extends a direction of the sipe length L14, which, in the embodiment shown, would be in the direction of the tread width W10. Of course, because the sipe 14 may be formed in any arrangement within the tread, the sipe length and width may extend at least partially in any direction of the tread length or width. Because the undulating thickness does not pertain to or operate as any surface geometry, the undulating thickness of the sipe can be referred to as an undulating body. When, as noted above, a sipe more generally is planar or contoured in form, it can be said that the body of the sipe is planar or contoured.

The first path can be described as being a non-linear, undulating path, as the first path forms a plurality of undulations. In the embodiment shown, the undulating path comprises a series of line segments, such as to form a stepped or zig-zagging undulating path, although in other variations, the undulating path may be curvilinear. A frame portion 15 of the sipe having a thickness extending in the length direction of the sipe and measured in the thickness direction is formed by a thickened portion of the sipe surrounding the undulating thin portion 17 of the sipe. The amplitude of the undulations in the height direction H14 of the undulated portion is no greater than the thickness of the frame portion surrounding the undulation. The amplitude of the undulations is measured from the peak of the protrusion in the thickness direction on the first side of the sipe to the adjacent side at the base of the undulation.

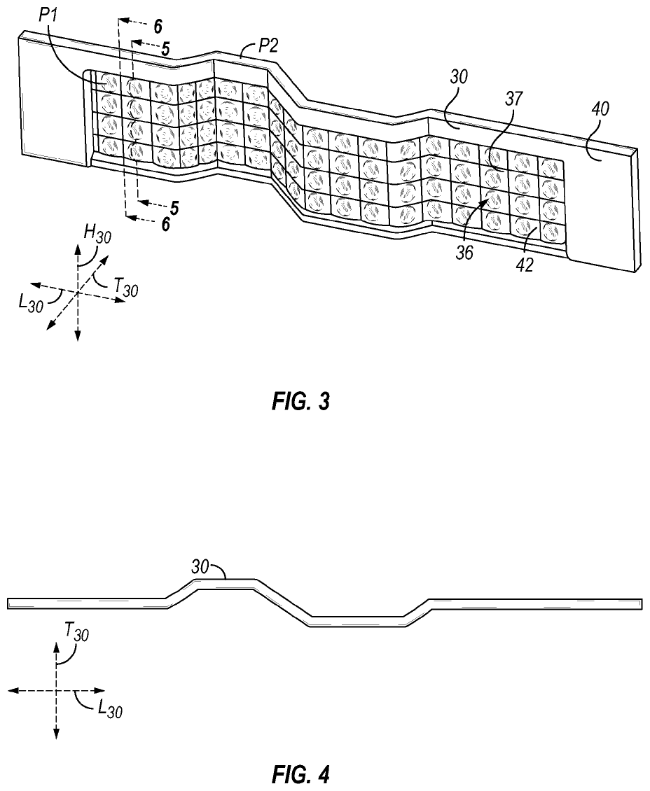

As it is appreciated that the surface geometry described herein may be applied to any sipe known to one of ordinary skill in the art, or any obvious variation thereof, in particular variations of the sipes described herein, a sipe (and its thickness or body) may not undulate at all in a specific direction or at a specific location of the sipe or may undulate in one or more directions. For example, a sipe (and its thickness or body) may not only undulate back and forth as the sipe extends in a particular direction, the sipe (and its thickness or body) may also undulate back and forth as the sipe extends in another direction. In extending in the second direction, it can be said that the sipe (and its thickness or body) undulates along a second path (a second non-linear, undulating path) in a second direction. For example, with reference to FIG. 3, a sipe-molding member 30, which forms the sipe 14, is shown that undulates as the sipe extends in both a direction of the sipe-molding member height H30 (via non-linear, undulating path P1) and a direction of the sipe-molding member length L30 (via a second stepped, undulating path comprising linear segments, P2). The thin sipe-molding portion 42 possesses the series of undulations 32 in the height direction H30. In this embodiment, the two directions are perpendicular to each other. Still, in other embodiments, the two directions may be biased to each other by an angle other than 90 degrees (perpendicular). It is noted that with respect to FIG. 3, the thick sipe-molding portion 40, responsible for molding the frame portion 15 of the sipe, and the thin sipe-molding portion 42 both possess an undulation along a path extending in the sipe-molding portion's length direction L30 of the sipe-molding member. It is further noted that the amplitude of the undulation of both the thick sipe-molding portion 40 and thin sipe-molding portion 42 along a path extending in the length direction L30 may be greater than the thickness of the thick sipe-molding portion 40 as shown in FIG. 4, showing an elevated view in the height direction relative to the sipe 30. This is permissible provided the undulations extending along a path in the height direction do not have an amplitude greater than the thickness of the thick sipe-molding portion 40.

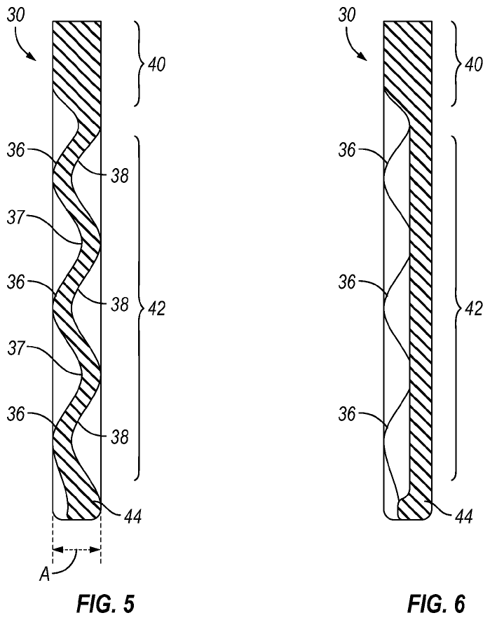

A cross section of the embodiment is shown in FIG. 5, taken through line 5-5 of FIG. 4. Three projections 36 are shown in cross section with the amplitude measured in the sipe-molding member 30 thickness direction T30 which is no greater than that of thick sipe molding portion's 40 thickness measured in the thickness direction T30 of the sipe-molding member. A recess 38 is positioned opposite of each protrusion 36. The thin sipe-molding portion 42 terminates in the sipe molding portion's height direction H30 with a teardrop shape void-forming portion 44. FIG. 6 shows a cross section of the embodiment taken through line 6-6 of FIG. 4. As seen here, some portions of the thin sipe-molding portion 42 may lack undulations. In this particular vertical portion lies between the circular protrusion 36 in the thin sipe-molding portion 42 of the sipe-molding member 30.

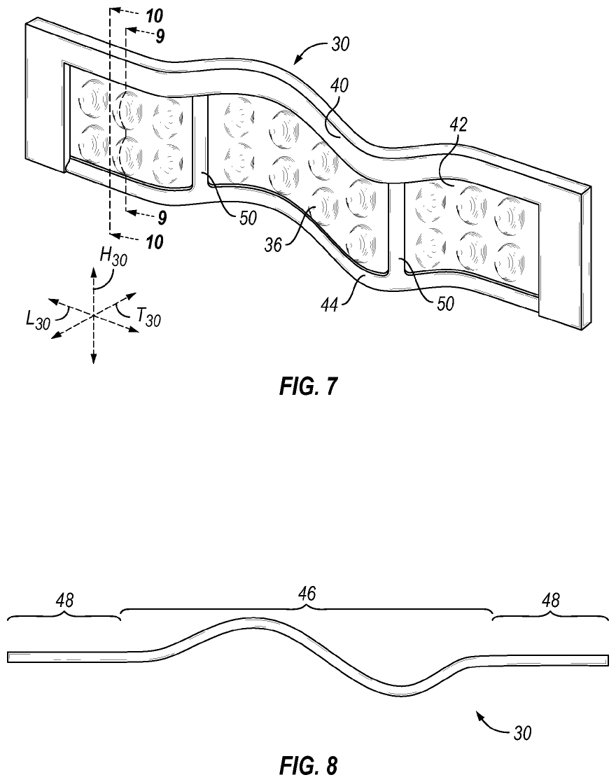

FIG. 7 depicts another embodiment having a non-linear undulation along the length L30 of the sipe-molding portion 30 of the mold. This lengthwise oriented curved undulation portion 46 along the length of the sipe-molding portion does not have linear portions except at the end extents which are lengthwise oriented linear portions 48, shown in FIG. 8. The thin sipe-molding portion 42 possesses stiffeners 50 which are formed by thickened portions of the thin sipe-molding portion. The stiffeners 50 may be as thick as the thick sipe-molding portion 40 or, as depicted in this embodiment, less thick than the thick sipe-molding portion 40 but thicker than the thin sipe-molding portion 42. These particular stiffeners 50 are in a location free of protrusions 36 and are oriented in the height direction H30 of the sipe-molding member 30. As with the previous embodiments, this sipe-molding member 30 embodiment does not possess undulations in the sipe height direction H30 that have amplitudes greater than the thick sipe-molding portion 40.

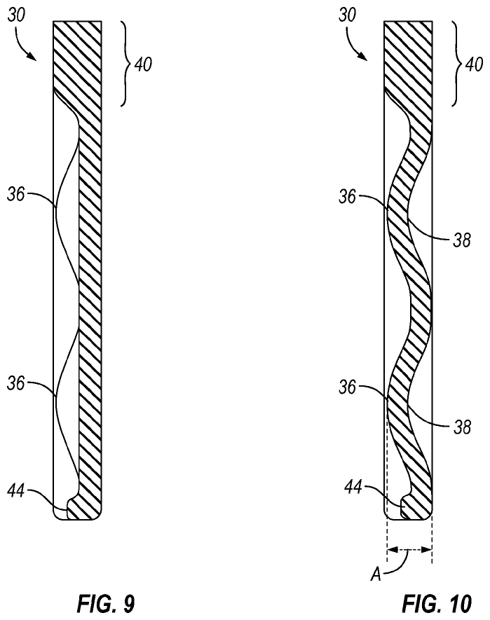

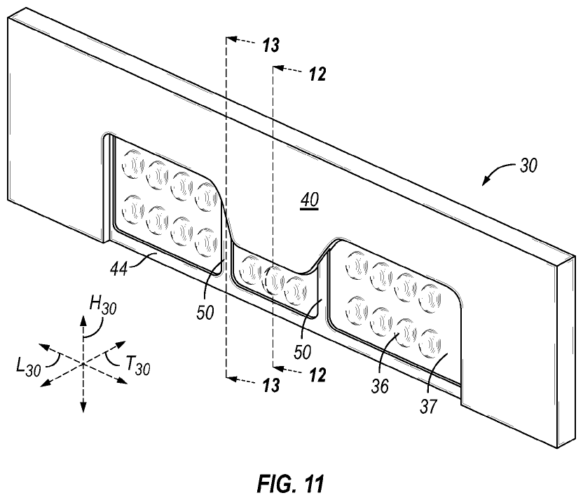

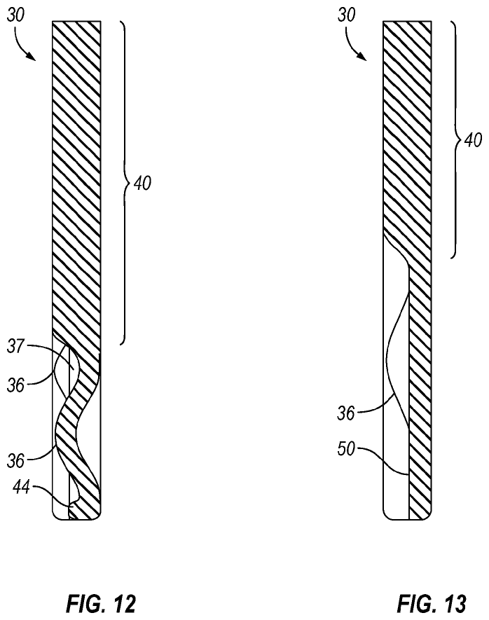

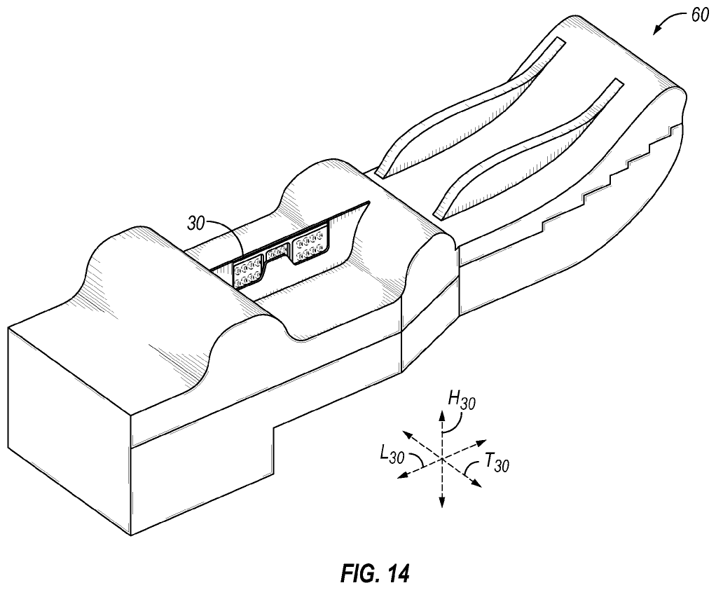

FIG. 9 and FIG. 10 are cross sections taken along lines 9-9 and 10-10, respectively, showing the sipe-molding member's cross section in the height direction H30. The amplitude A of the undulations along a path extending in the height direction formed by the protrusions 36 of the sipe-molding member is less than the thickness of the thick sipe-molding portion 40 measured in the sipe-molding member thickness direction T30 FIG. 11 depicts yet another embodiment having a thick sipe molding portion 40 having a height measured in the sipe height direction H30 that varies along the sipe length direction L30. The sipe molding member 30 of this embodiment is linear along the length of the sipe, with the exception of the undulations formed by the protrusions 36 in the thin sipe-molding portion 42. In this embodiment the protrusions 36 are positioned along varying heights in the sipe height direction H30 as shown by the slightly lower positioning of the middle three protrusions 36. Stiffeners 50 provide additional durability to the thin sipe-molding portion of the sipe-molding member 30. FIG. 12 and FIG. 13 show cross sections taken along lines 12-12 and 13-13 in FIG. 11 respectively showing, as with the other embodiments, that the amplitude of the undulations in the height direction H30 of the sipe-molding member 30 are no greater than the thickness of the thick sipe-molding portion 40 of the sipe molding member. FIG. 11 shows the protrusions 36 arranged in rows, forming a left pair of rows of four protrusions per row, a middle row of three protrusions and a right pair of rows of four protrusions per row. FIG. 12 shows the middle row of protrusions offset from the left and right rows of protrusions such that the rows adjacent to the middle row are shifted such that each projection in the adjacent row is arranged adjacent to the depression 37 of the adjacent row. In this way, the protrusions are not at the same height and adjacent rows are offset. In this particular embodiment the adjacent rows of protrusions are offset in the height direction of the sipe-molding member by one half of the distance between adjacent protrusions.

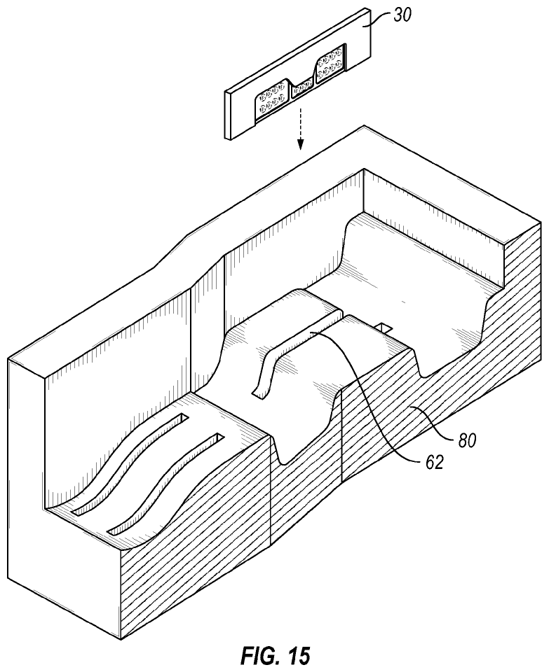

The sipe-molding members 30 disclosed here are useful for tire molds and particularly for molds comprised of a plurality of mold pieces which are responsible for making up the tread. Such molds are referred to in the industry as “puzzle molds” and are characterized by having a multitude of micro gaps formed by the separating lines between the single segments through which gasses can escape the mold during the tire molding process. A single piece of a tire puzzle mold 60 is shown in FIG. 14. The gaps are intended to have a tight tolerance so that the gasses can escape without discharge of the rubber mixture during molding. The outer surface of the mold needs few or no exhaust vents, such as small holes drilled in the mold which tend to form elongated hair-like vent spews. Eliminating the spews makes for a smooth finished product and reduces the need for post-molding removal of excess rubber which affects the aesthetics of the tire.

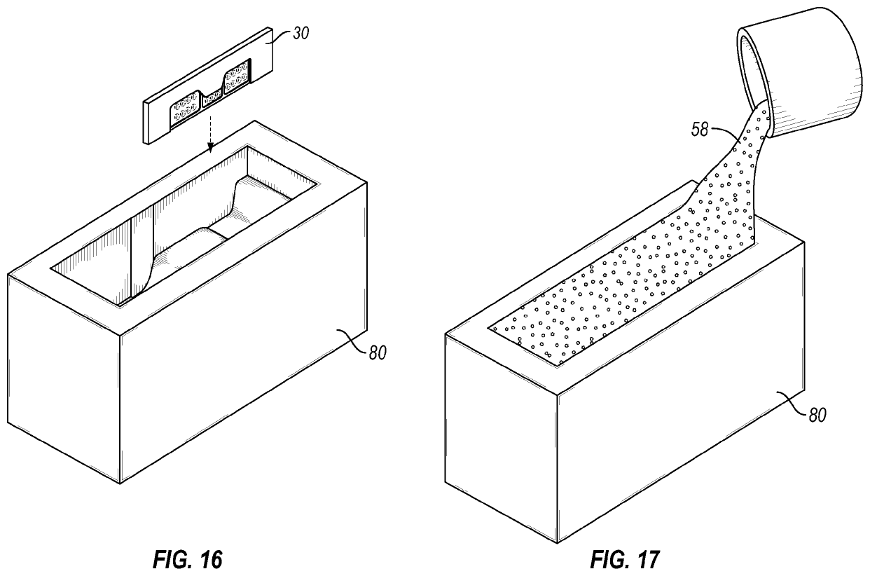

When making “puzzle molds”, one method to create the mold 60 is to create a mold negative 80 as shown in FIG. 15. The mold negative 80 possesses a slot 82 for receiving and temporarily retaining the sipe-molding member 30 in the correct position relative to the other surface features of the mold. During the process of making the tire mold 60, a mold negative 80 is created and the sipe-molding member 30, which will become part of the mold 60, is inserted into the sipe-molding member retention slot 82 as shown in FIG. 16.

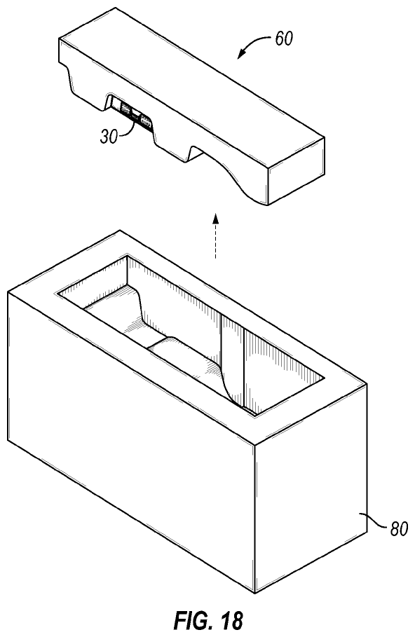

The mold material 58, usually metal, used to make the mold 60 is poured or cast into the mold negative 80 as shown in FIG. 17 and allowed to harden. The gap between the slot 82 and the sipe-molding member 30 is small enough to prevent the mold material 58 from filling in the undulations of the thin sipe-molding portion 42 of the sipe-molding member 30. The portions of the sipe-molding member 30 extending outside of the slot 82 of the mold negative 80 are captured by the mold material 58, such that when the mold 60 is removed from the mold negative 80, the sipe-molding member 30 is retained in the mold 60 in the correct location as shown in FIG. 18.

A plurality of these individual molds 60 are arranged circumferentially as part of a tire mold and form the surface of the tread of a tire.

The amplitude of the sipe-molding member 30 undulations in the height direction of the sipe H14 must have an amplitude measured in the thickness direction of the sipe T14 that is equal to or smaller than the thickness of the thick sipe-molding portion to allow that sipe to release from the mold negative 80 and allow the mold 60 to separate from the mold negative 80.

As to the surface geometry for application to any desired sipe, and therefore for application to one or both of the opposing tread sides or surfaces between which the sipe is arranged and defined, the resulting geometry provides surface geometry features comprising a plurality of projections and/or recesses that form a or non-planar or contoured surface, much like a textured surface, such that opposing sides of the tread between which the sipe is arranged observe increased friction when relative movement between the two sides is attempted during tire operation. In applying the surface geometry to the sipe, the surface geometry is also applied to the plurality of undulations, or, in other words, the sipe body. It is appreciated that spaced apart projections form an interstitial space arranged between the projections, the interstitial space being a recess relative to the projections. Of course, the opposite is true as well, where spaced apart recesses form an interstitial space arranged between the recesses, the interstitial space being a projection relative to the recesses. Therefore, projections and recesses are used with reference to each other, and not as to how each is formed along a surface. Additionally, it is noted that a projection of the sipe is associated with a corresponding recess on one of the opposing sides or surfaces, and vice versa. In certain embodiments, the surface geometry features are formed such that surface geometry features arranged on the opposing sides generally interlock, such as when the opposing sides are mirrored opposites of each other, for example.

With reference to FIGS. 1 and 2, surface geometry features comprising a plurality of projections 18 and corresponding recesses 20 is shown along one of the opposing sides or surfaces 16 of the tread 10 between which the sipe is arranged and defined. The plurality of projections 18 and recesses 20 are spaced along the length L14 and height H14 of the sipe. In the variation shown, the projections and recesses are uniformly spaced apart, although it is appreciated that in other variations, the projections and/or recesses may be uniformly or non-uniformly spaced apart as desired. While the arrangement of projections 18 and recesses 20 is shown to form a generally smooth or rounded contoured surface, it is contemplated that more defined projections and/or recesses may be provided such that the surface is not smoothly contoured, such as where the projections form cylinders, rectangles, or pointed cones, for example. In particular embodiments, the smoothly or rounded contoured surface shown in FIG. 3 comprising a plurality of uniformly spaced projections 36 and recesses 38 represented a hemispherical shape.

The smooth or rounded contoured is also described as extending along an undulating path in two perpendicular directions at particular locations. In particular embodiments, with particular reference to FIGS. 3, 4, 5 and 6, the plurality of projections 36 of the sipe-molding member are spaced apart from the middle of one projection to the middle of an adjacent projection, or from peak to peak and have a height (also referred to as an amplitude). The height or amplitude is measured from the base or bottom of the projection. The projections and recesses are arranged along an undulating path forming a plurality of undulations having a period (which is a spacing from the middle of one projection to the middle of an adjacent projection, or from peak to peak) of 0.8 to 2.0 mm, 1.5 to 2.0 mm, or 1.6 to 1.8 mm, and an amplitude which is less than the thick sipe molding portion, generally in the range of 0.3 to 0.9 mm or 0.5 to 0.7 in other variations, or as shown in the embodiment of FIG. 11, having a frame thickness of 0.6 mm. In such embodiments the undulations are in the thin portion which is in the range of 0.15 mm to 0.4 mm thick from a first side of the thin portion to the second side of the thin portion. In such embodiments, amplitude measures the distance between the base to the peak along the undulation within a single period. It is appreciated that the undulations may be formed along the surface without impacting the other side of the sipe, or the sipe thickness may undulate along the undulating path, such that where a projection is formed on one side of the sipe, a recess is formed opposite the projection on the other side of the sipe. In at least one embodiment, the undulation has a period of between 1.0 mm and 2.4 mm.

It is appreciated that any sipe described herein may be formed by any known method for forming sipes in treads. For example, a method for forming a tire tread comprises a step of molding each of a plurality of sipes using a sipe-molding member. The sipe-molding member includes a portion having the same shape as any particular sipe described herein, where such portion of the sipe-molding member is a solid form of the sipe, which is a void. Each sipe-molding member is arranged within the tread thickness, between opposing surfaces or sides of the tread within the tread thickness. The sipe-molding member thickness T30 undulates back and forth along a first path P1 as the sipe-molding member extends in a direction of the sipe-molding member height H30 (or length L30). Further steps of such methods include removing the sipe-molding member, which leaves a sipe remaining within the tread, the sipe having a void shaped as the sipe-molding member and a plurality of projections corresponding to the plurality of projections arranged along the sipe-molding member.

It is appreciated that the sipe-molding member may comprise any form desired by one of ordinary skill, for use in any known molding apparatus. For example, in certain instances, such as is shown in one exemplary embodiment in FIGS. 3-10, a sipe-molding member 30 includes a thick sipe-molding portion 40 surrounding at least a portion of a thin sipe-molding portion 42. In these embodiments, both the thick and thin portions include undulations along the direction of the length of the sipe, in addition to the thin portion undulating in a direction of the sipe length and height. In other variations, such as shown in FIGS. 1, 2, 11-13, only the thin portion of the sipe includes the surface undulations discussed herein. It is apparent that the thick sipe-molding portion is thicker than the thin sipe-molding portion. In different variations, the thick-molding portion may partially or fully surround the thin sipe-molding portion, in different variations.

The undulations formed by the protrusions 36, and particularly by the circular protrusions as shown in the embodiments shown herein, have been shown to produce tires with excellent wear results. Comparative testing was performed comparing a tire having a tread pattern molded using a puzzle mold construction. A tire having a plurality of sipes similar to that depicted in FIGS. 11-13 was compared to a tire having a plurality of sipes having a smooth surface (without undulations) were compared. The tire possessing the sipes formed by the sipe-molding member depicted in FIGS. 11-13 displayed 10% improvement in wear rate without significant changes in the other tire performances when compared with non-undulated sipes over the wear life of the tire. Such improved results are surprising as previous tire molds achieving such results required undulated sipes requiring a more complex molding process that allowed for demolding of the mold and mold negative or required welding of the sipe-molding member 30 into the mold forming the tire, both adding additional expense to the mold and finished product. The use of this technology brings complex sipe design to tires created from economically fabricated puzzle molds.

It is appreciated that any tread discussed herein may be arranged along an annular pneumatic tire, or may be formed separately from a tire as a tire component for later installation on a tire carcass, in accordance with any technique or process known to one of ordinary skill in the art. For example, the treads discussed and referenced herein may be molded with a new, original tire, or may be formed as a retread for later installation upon a used tire carcass during retreading operations. Therefore, when referencing the tire tread, a longitudinal direction of the tire tread is synonymous with a circumferential direction of the tire when the tread is installed on a tire. Likewise, a direction of the tread width is synonymous with an axial direction of the tire or a direction of the tire width when the tread is installed on a tire. Finally, a direction of the tread thickness is synonymous with a radial direction of the tire when the tread is installed on a tire. It is understood that the inventive tread may be employed by any known tire, which may comprise a pneumatic or non-pneumatic tire, for example.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.” The citation of any document is not an admission that it is prior art with respect to any invention disclosed or claimed herein or that it alone, or in any combination with any other reference or references, teaches, suggests or discloses any such invention.

Further, to the extent that any meaning or definition of a term in this document conflicts with any meaning or definition of the same term in a document incorporated by reference, the meaning or definition assigned to that term in this document shall govern.

What is claimed is:

1. A tire mold comprising:
a plurality of mold components each mold component having:
a mold component length extending in a lengthwise direction, the lengthwise direction being a circumferential direction when the mold components are arranged to form an assembled tire mold;
a mold component width extending in a lateral direction, the lateral direction being perpendicular to the mold component lengthwise direction;
a mold component thickness extending in a depth wise direction from an outer, tread forming surface of the mold, the depth wise direction being perpendicular to both the mold component lengthwise direction and the mold component widthwise direction;
a plurality of sipes-molding members each having a sipe-molding member length extending at least partially in a direction of the mold component length or mold component width, a sipe-molding member height extending at least partially in a direction of the mold component thickness and perpendicular to the length, and a sipe-molding member thickness, each sipe-molding member extending in the mold component thickness direction from the mold component surface,
where each of the plurality of sipe-molding members each having a thick sipe-molding portion having a thickness and a thin sipe-molding portion located within the thick sipe-molding portion, the thin sipe molding portion having a thickness which is less than the thickness of the thick sipe-molding portion,
where at least one of the opposing sides of the sipe-molding member is arranged includes a plurality of projections located on the thin sipe-molding portion, the plurality of projections being spaced apart and each projection forming an undulation in the height direction of the sipe-molding member, the undulation having an amplitude no greater than the thickness of the thick sipe-molding portion,
where one or more of the opposing sides of the sipe-molding member thickness include a plurality of recesses, the plurality of recesses being spaced apart and each recess forming an undulation in the height direction of the sipe-molding member, the undulation having an amplitude no greater than the thickness of the thick sipe molding portion.

2. The tire mold of claim 1, where the plurality of projections are arranged in rows, where adjacent rows are shifted relative each other such that each projection in any row is arranged adjacent to one of the depressions in an adjacent row.

3. The tire mold of claim 1, where the projections and recesses are formed along the thickness of the sipe that is also undulating back and forth along a non-linear, undulating path as the sipe extends in the direction of the sipe height or sipe length, the non-linear, undulating path forming a plurality of undulations and having a period of 1.0 to 2.4 millimeters and an amplitude of no greater than the thick sipe-molding portion thickness.

4. The tire mold of claim 1, where the other of the opposing sides of the sipe thickness includes a plurality of projections, the plurality of projections being spaced apart and each having a height measuring no greater than the thick sipe-molding portion thickness.

5. The tire mold of claim 1, where for each of the plurality of sipes, the plurality of projections and the plurality of recesses are arranged in an alternating projection-recess arrangement along the sipe length and sipe height, such that the opposing sides of the tread are arranged in a mating configuration.

6. The tire mold of claim 1, where the thick sipe-molding portion thickness is measured in the range of 0.3 mm to 0.9 mm.

7. The tire mold of claim 1, where the thin portion thickness is measured in the range of 0.15 mm to 0.4 mm.

8. A method of creating a tire mold comprising:
placing a sipe-molding member into a slot in a mold negative;
placing mold material in the mold negative to form a mold component;
removing the mold component from the mold negative with the sipe molding member embedded in the mold component;
wherein the mold component comprises:
a mold component length extending in a lengthwise direction, the lengthwise direction being a circumferential direction when the mold components are arranged to form an assembled tire mold;
a mold component width extending in a lateral direction, the lateral direction being perpendicular to the mold component lengthwise direction;
a mold component thickness extending in a depth wise direction from an outer, tread forming surface of the mold, the depth wise direction being perpendicular to both the mold component lengthwise direction and the mold component widthwise direction;
wherein the sipe molding member comprises:
a sipe-molding member length extending at least partially in a direction of the mold component length or mold component width, a sipe-molding member height extending at least partially in a direction of the mold component thickness and perpendicular to the sipe-molding member length, and a sipe-molding member thickness, each sipe-molding member extending in the mold component thickness direction from the mold component surface;
where the sipe-molding member has a thick sipe-molding portion having a thick sipe-molding portion thickness and a thin sipe-molding portion located within the thick sipe-molding portion, the thin sipe-molding portion having a thin sipe-molding portion thickness which is less than the thick sipe-molding portion thickness;
where at least one of the opposing sides of the sipe-molding member is arranged includes a plurality of projections located on the thin sipe-molding portion, the plurality of projections being spaced apart and each projection forming an undulation in the height direction of the sipe-molding member, the undulation having an amplitude no greater than the thick sipe-molding portion thickness,
where one or more of the opposing sides of the sipe-molding member thickness include a plurality of recesses, the plurality of recesses being spaced apart and each recess forming an undulation in the height direction of the sipe-molding member, the undulation having an amplitude no greater than the thick sipe molding portion thickness;
wherein the thick sipe-molding portion engages the slot in the mold negative such that no mold material reaches the thin sipe molding portion when the mold material is placed into the mold negative.

9. The method of creating a tire mold of claim 8, wherein placing the mold material into the mold is by casting.

10. The method of creating a tire mold of claim 8, where the plurality of projections are arranged in rows, where adjacent rows are shifted relative each other such that each projection in any row is arranged adjacent to one of the depressions in an adjacent row.

11. The method of creating a tire mold of claim 8, where the projections and recesses are formed along the sipe thickness that is also undulating back and forth along a non-linear, undulating path as the sipe extends in the direction of the sipe height or sipe length, the non-linear, undulating path forming a plurality of undulations and having a period of 1.0 to 2.4 millimeters and an amplitude of no greater than the thick sipe-molding portion thickness.

12. The method of creating a tire mold of claim 8, where the other of the opposing sides of the sipe thickness includes a plurality of projections, the plurality of projections being spaced apart and each having a height measuring no greater than the thick sipe-molding portion thickness.

13. The method of creating a tire mold of claim 8, where for each of the plurality of sipes, the plurality of projections and the plurality of recesses are arranged in an alternating projection-recess arrangement along the length and height of the sipe, such that the opposing sides of the tread are arranged in a mating configuration.

14. The method of creating a tire mold of claim 8, where the thick sipe-molding portion thickness is measured in the range of 0.3 mm to 0.9 mm.

15. The method of creating a tire mold of claim 8, where the thin portion thickness is measured in the range of 0.15 mm to 0.4 mm.

16. The tire mold of claim 2, where the projections and recesses are formed along the thickness of the sipe that is also undulating back and forth along a non-linear, undulating path as the sipe extends in the direction of the sipe height or sipe length, the non-linear, undulating path forming a plurality of undulations and having a period of 1.0 to 2.4 millimeters and an amplitude of no greater than the thick sipe-molding portion thickness.

17. The tire mold of claim 16, where the other of the opposing sides of the sipe thickness includes a plurality of projections, the plurality of projections being spaced apart and each having a height measuring no greater than the thick sipe-molding portion thickness.

18. The tire mold of claim 17, where for each of the plurality of sipes, the plurality of projections and the plurality of recesses are arranged in an alternating projection-recess arrangement along the sipe length and sipe height, such that the opposing sides of the tread are arranged in a mating configuration.

19. The tire mold of claim 18, where the thick sipe-molding portion thickness is measured in the range of 0.3 mm to 0.9 mm.

20. The tire mold of claim 19, where the thin portion thickness is measured in the range of 0.15 mm to 0.4 mm.
